(19) United States
(12) Patent Application Publication
(10) Pub. No.: US 2004/0261591 A1
(43) Pub. Date: Dec. 30, 2004

(54) Table saw with a positioning unit for positioning a rip fence unit thereof

(76) Inventors: Juei-Seng Liao, Taichung City (TW); Pei-Lieh Chiang, Taichung City (TW)

Correspondence Address: TROP PRUNER & HU, PC, 8554 KATY FREEWAY, SUITE 100, HOUSTON, TX, 77024, US

(21) Appl. No.: 10/646,227

(22) Filed: Aug. 22, 2003

(30) Foreign Application Priority Data
Jun. 30, 2003 (TW) 092211966

(51) Int. Cl. B23D 19/00; B23D 33/02

(52) U.S. Cl. 83/477.2; 83/478; 83/477

(57) ABSTRACT

A table saw includes a base, a rip fence unit with a sliding member mounted slidably on a rail unit on the base, and a positioning unit having a clamping member disposed below the rail unit and swingable between a clamping position, in which the clamping member cooperates with the sliding member to clamp the rail unit therebetween, and a releasing position, in which the clamping member is disconnected from the rail unit.

### CROSS-REFERENCE TO RELATED APPLICATION

This application claims priority of Taiwanese Application No. 092211966, filed on Jun. 30, 2003.

### BACKGROUND OF THE INVENTION

1. Field of the Invention

This invention relates to a table saw with a positioning unit for positioning a rip fence unit thereof.

2. Description of the Related Art

FIG. 1 illustrates a conventional table saw that includes a rip fence 11 with a guide 12 mounted slidably on a rail 121 formed on a worktable (not shown). A positioning unit includes a front clamping member 16 that has one end secured to the guide 12, a rear clamping member 13 that has one end secured to a rear end of the rip fence 11, and a screw rod 14 that extends through the front and rear clamping members 16, 13 and that is rotatable to move the front and rear clamping members 16, 13 toward and away from each other. The other end of the front clamping member 16 and the other end of the rear clamping member 13 are respectively disposed adjacent to two opposite sides of the worktable (not shown) so that the front and rear clamping members 16, 13 clamp the worktable therebetween upon tightening of the screw rod 14. A handle 17 is attached to the screw rod 14 for facilitating turning of the screw rod 14.

The conventional table saw is disadvantageous in that tightening and loosening of the screw rod 14 for adjusting the position of the rip fence 11 during operation of the table saw is relatively inconvenient. Moreover, the other end of the rear clamping member 13 tends to wobble undesirably, which can result in improper positioning of the rip fence 11.

### SUMMARY OF THE INVENTION

Therefore, the object of the present invention is to provide a table saw with a positioning unit that is capable of overcoming the aforesaid drawbacks of the prior art.

According to the present invention, there is provided a table saw that comprises: a base; a saw blade mounted rotatably on the base; a rail unit mounted on the base and extending in a longitudinal direction; a rip fence unit including a rip fence that extends in a transverse direction relative to the longitudinal direction, and a sliding member that is secured to the rip fence, and that is disposed above and mounted slidably on the rail unit so as to be slidable toward and away from the saw blade in the longitudinal direction; and a positioning unit mounted on the rip fence unit and including a clamping member that is disposed below and swingable toward and away from the rail unit, and that is operable by an external force applied thereto so as to swing between a clamping position, in which the clamping member abuts against the rail unit and cooperates with the sliding member to clamp the rail unit therebetween, thereby arresting sliding movement of the sliding member on the rail unit, and a releasing position, in which the clamping member is disconnected from the rail unit so as to permit sliding movement of the sliding member together with the rip fence on the rail unit.

### BRIEF DESCRIPTION OF THE DRAWINGS

In drawings which illustrate an embodiment of the invention,

FIG. 1 is a fragmentary sectional view of a conventional table saw;

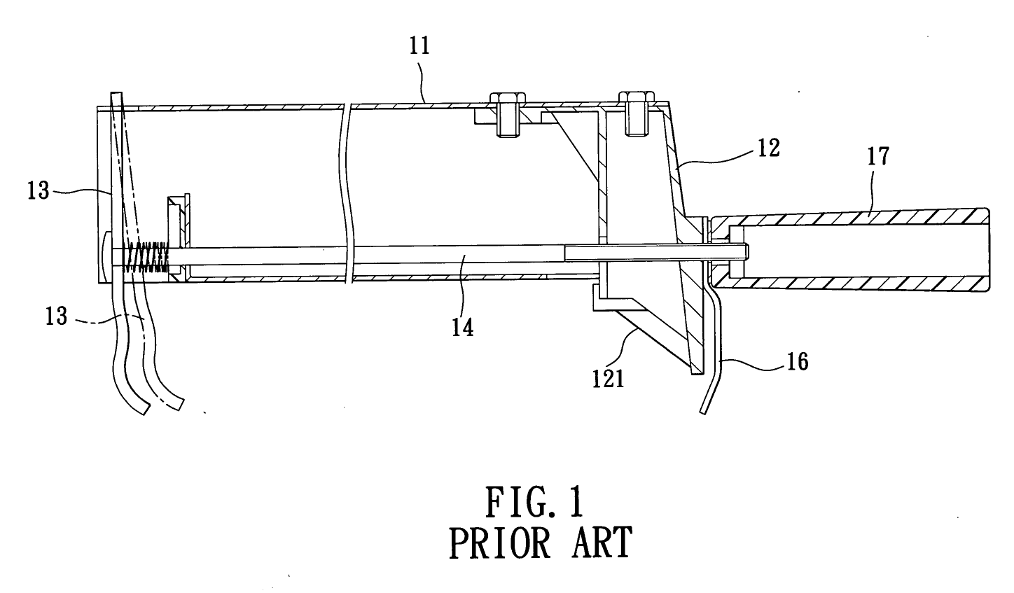

FIG. 2 is a side view of a table saw embodying this invention;

FIG. 3 is a fragmentary exploded perspective view of the table saw of FIG. 2;

FIG. 4 is an exploded perspective view of a positioning unit of the table saw of FIG. 2;

FIG. 5 is a fragmentary perspective view to illustrate how a clamping member of the positioning unit of the table saw of FIG. 2 clamps a rip fence unit;

FIG. 6 is a fragmentary, perspective view to illustrate how the clamping member of the positioning unit of the table saw of FIG. 2 is disconnected from the rip fence unit; and

FIG. 7 is a fragmentary perspective view to illustrate how a fine adjusting unit is operated to engage a rail unit of the table saw of FIG. 2.

### DETAILED DESCRIPTION OF THE PREFERRED EMBODIMENT

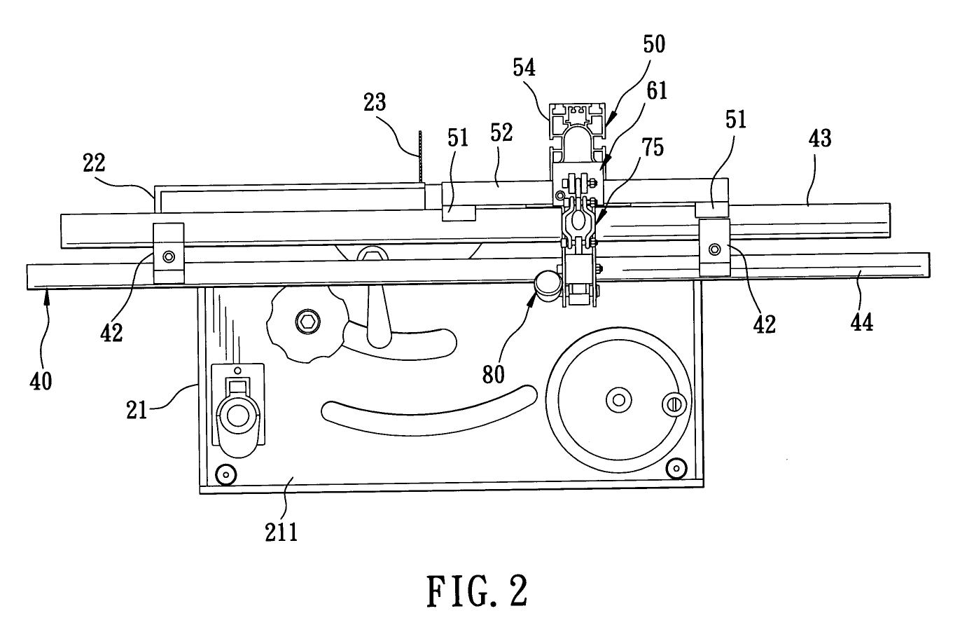

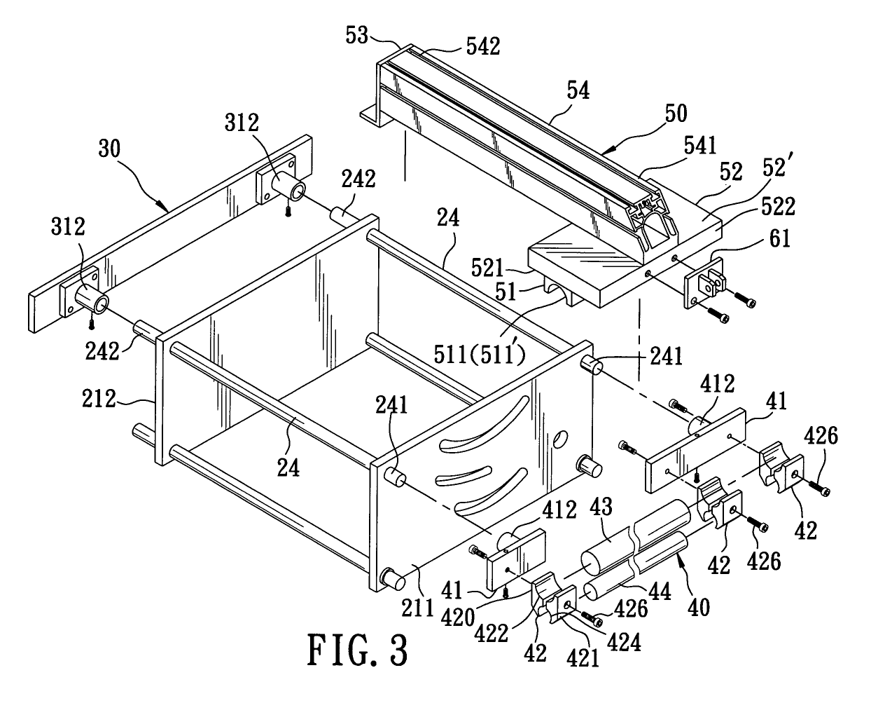

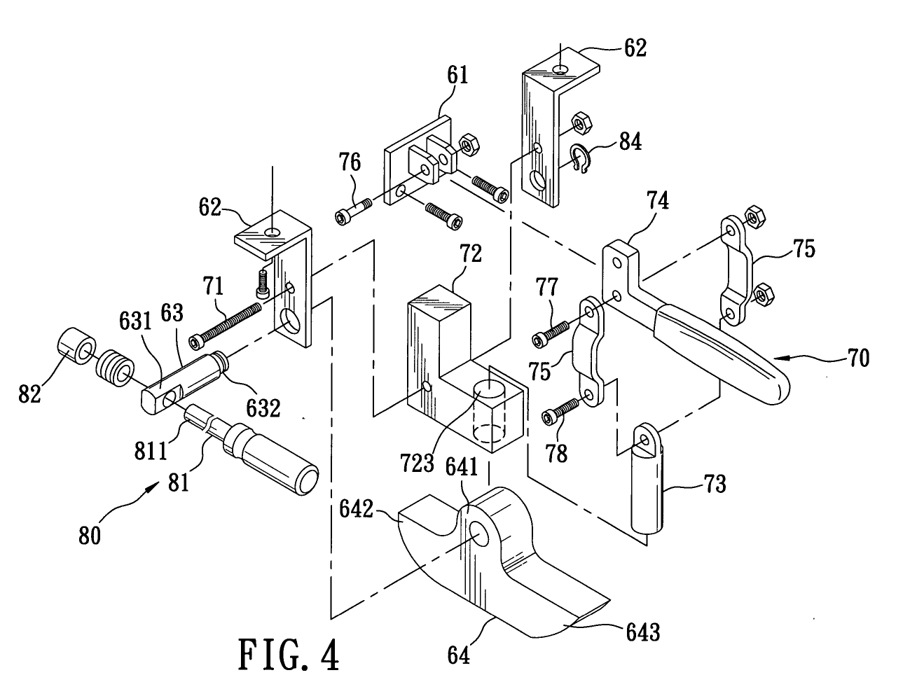

FIGS. 2 to 5 illustrate the preferred embodiment of the table saw of this invention for cutting a wooden workpiece (not shown).

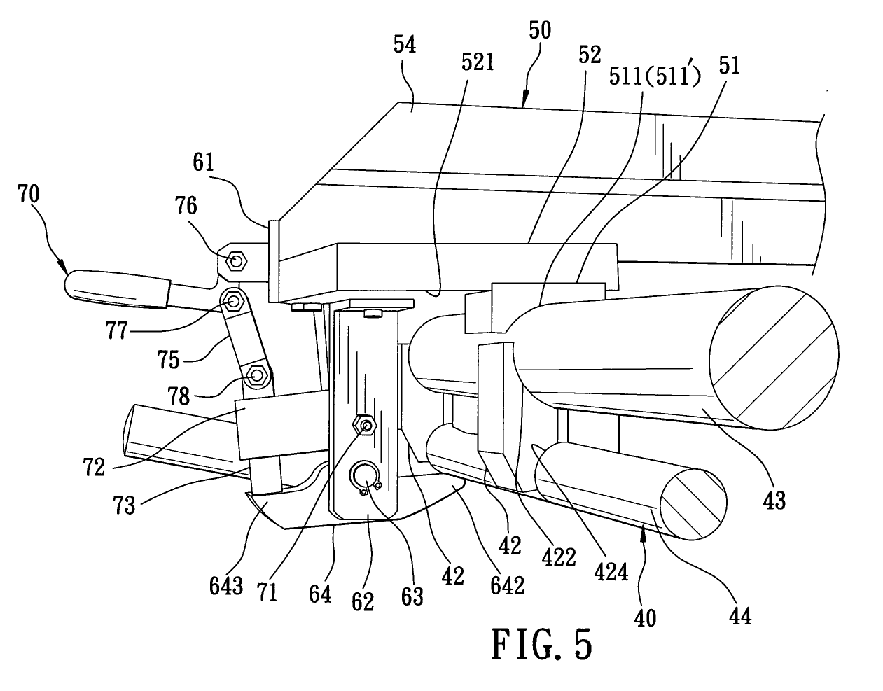

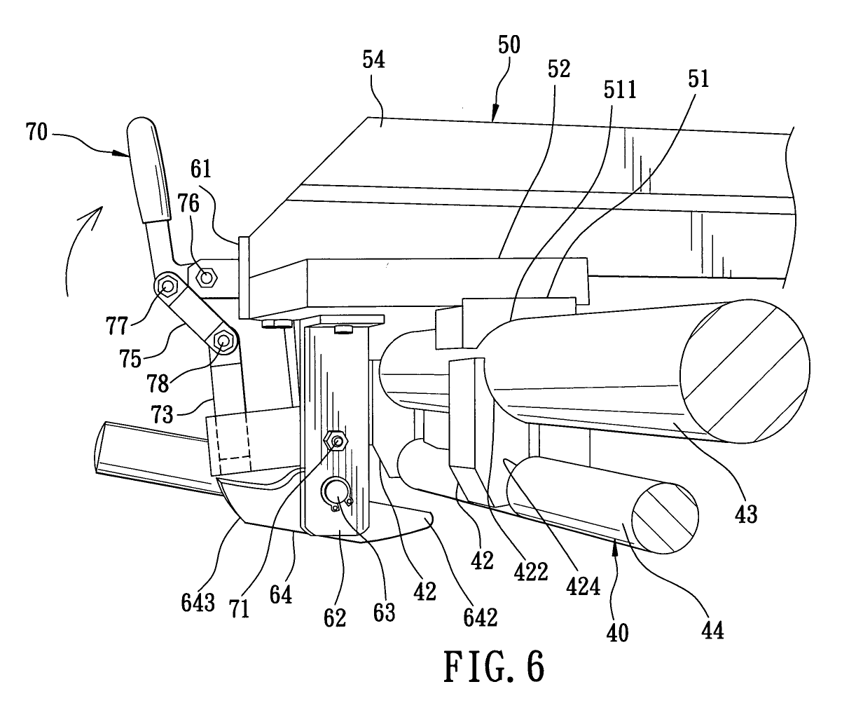

The table saw includes: a base 21; a worktable 22 mounted on the base 21; a saw blade 23 mounted rotatably on the base 21; a rail unit 40 mounted on the base 21 and extending in a longitudinal direction; a rip fence unit 50 including a rip fence 54 that extends in a transverse direction relative to the longitudinal direction, and a sliding member 52 that is secured to the rip fence 54, and that is disposed above and mounted slidably on the rail unit 40 so as to be slidable toward and away from the saw blade 23 in the longitudinal direction; and a positioning unit mounted on the rip fence unit 50 and including a clamping member 64 that is disposed below and swingable toward and away from the rail unit 40, and that is operable by an external force applied thereto so as to swing between a clamping position (see FIG. 5), in which the clamping member 64 abuts against the rail unit 40 and cooperates with the sliding member 52 to clamp the rail unit 40 therebetween, thereby arresting sliding movement of the sliding member 52 on the rail unit 40, and a releasing position (see FIG. 6), in which the clamping member 64 is disconnected from the rail unit 40 so as to permit sliding movement of the sliding member 52 together with the rip fence 54 on the rail unit 40.

The base 21 includes parallel front and rear plates 211, 212 that are connected through a pair of upper connecting rods 24 and a pair of lower connecting rods. The upper connecting rods 24 respectively extend through two opposite sides of the front plate 211 and two opposite sides of the rear plate 212, and have front ends that respectively define a pair of front studs 241 projecting frontwardly and respectively from the opposite sides of the front plate 211, and rear ends that respectively define a pair of rear studs 242 projecting rearwardly and respectively from the opposite sides of the rear plate 212. Each of a pair of rail-mounting brackets 41 is formed with a front sleeve 412 that is sleeved on a respective one of the front studs 241. At least two rail-holding members 42 (three rail-holding members 42 are employed in this preferred embodiment) are respectively secured to the rail-mounting brackets 41, and define C-shaped upper retaining grooves 422 which open upwardly and C-shaped lower retaining grooves 424 which open downwardly. The rail unit 40 includes an upper rail rod 43 that extends in the longitudinal direction into and through the upper retaining grooves 422 and that abuts against the rail-holding members 42 so as to be secured thereto, and a lower rail rod 44 that is parallel to the upper rail rod 43 and that extends in the longitudinal direction into and through the lower retaining grooves 424 and that abuts against the rail-holding members 42 so as to be secured thereto. The sliding member 52 includes a mounting plate 52′ and a pair of protrusions 51 that project downwardly from the mounting plate 52′ and that define a pair of C-shaped recesses 511 for extension of the upper rail rod 43 therethrough. Each of the recesses 511 in the protrusions 51 of the sliding member 52 is defined by a recess-defining wall 511′ that is in sliding contact with the upper rail rod 43 when the clamping member 64 is disposed at the releasing position, and that abuts tightly against the upper rail rod 43 when the clamping member 64 is disposed at the clamping position.

Each of the rail holding members 42 includes a screw bolt 426, a first half 420 that is secured to the respective one of the rail-mounting brackets 41, and a second half 421 that complements the first half 420 and that is adjustably secured to the first half 420 through the screw bolt 426 so as to adjust dimensions of the upper and lower retaining grooves 422, 524 and thus the tightness of the upper rail rod 43 in the upper retaining grooves 422 and the lower rail rod 44 in the lower retaining grooves 424.

The base 21 further includes a rear supporting plate 30 that is formed with a pair of rear sleeves 312 that are sleeved respectively on the rear studs 242. The rip fence 54 has front and rear ends 541, 542. The rip fence unit 50 further includes a rear mounting plate 53 that is secured to the rear end 542 of the rip fence 54 and that is seated slidingly on the rear supporting plate 30. The mounting plate 52′ of the sliding member 52 is secured to the front end 541 of the rip fence 54.

The positioning unit further includes a handle-mounting bracket 61 that is secured to and that projects frontwardly from a front side 522 of the mounting plate 52′ of the sliding member 52, a handle 70 having an L-shaped end 74 which is pivoted to the handle-mounting bracket 61 through a first pivot 76, a pair of clamp-mounting brackets 62 that are secured to a bottom side 521 of the mounting plate 52′ of the sliding member 52 and that are respectively disposed at two opposite sides of the handle-mounting bracket 61, and a guiding block 72 that is disposed between and that is secured to the clamp-mounting brackets 62 through screw means 71 and that is formed with a guiding hole 723 which extends in a vertical direction transverse to the longitudinal direction and the transverse direction. The clamping member 64 is disposed below the guiding block 72, extends in the transverse direction, and has a driven end 643 that is aligned with the guiding hole 723 in the vertical direction, and a clamping end 642 that is opposite to the driven end 643 in the transverse direction and that is disposed underneath the lower rail rod 44. The clamping member 64 is formed with a pivoting ea0r 641 between the driven end 643 and the clamping end 642 of the clamping member 64. The pivoting ear 641 is disposed between and is pivoted to the clamp-mounting brackets 62 so as to permit swinging of the clamping member 64. The positioning unit further includes a linking member 75 that is pivoted to the L-shaped end 74 of the handle 70 through a second pivot 77, and a pressing rod 73 that is pivoted to the linking member 75 through a third pivot 78 and that extends in the vertical direction into and through the guiding hole 723 so as to press the driven end 643 of the clamping member 64 to move downwardly when the handle 70 is turned downwardly, which results in upward movement of the clamping end 642 and abutment of the clamping end 642 against the lower rail rod 44, which, in turn, results in clamping of the rail unit 40 between the clamping end 642 of the clamping member 64 and the protrusions 51 of the sliding member 52. The clamping member 64 can only be moved from the clamping position to the releasing position by pulling the handle 70 upwardly. The positions of the first, second and third pivots 76, 77, 78 are arranged in a manner to prevent undesired movement of the clamping member 64 from the clamping position to the releasing position upon relief of the handle 70 from a downward external force applied thereto.

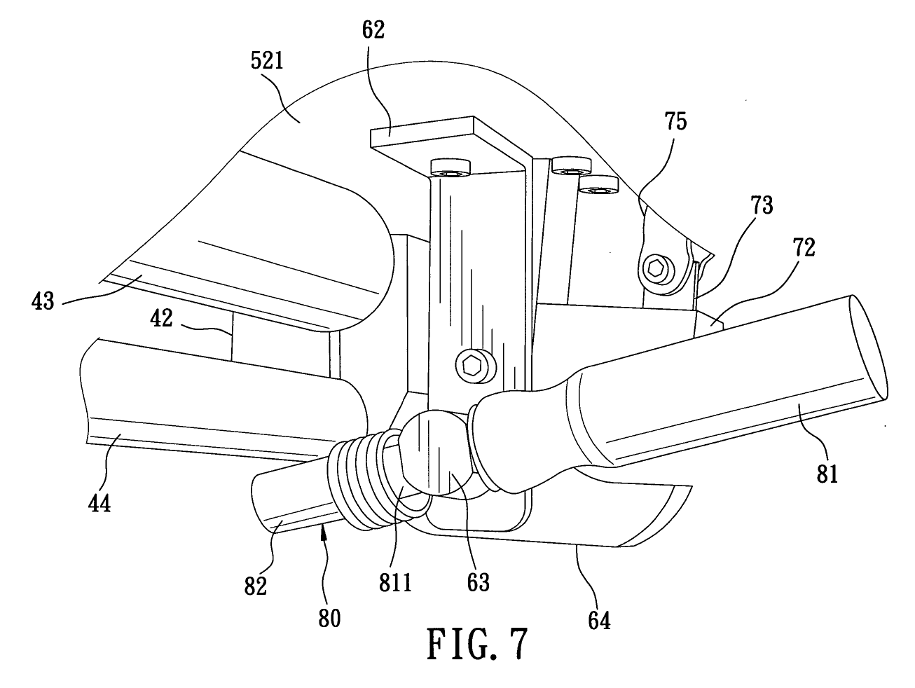

The positioning unit further includes a pivot pin 63 that extends in the longitudinal direction through the clamp-mounting brackets 62 and that has a connecting end 631 disposed adjacent to one of the clamp-mounting brackets 62, and a fixed end 632 that is fastened to the other of the clamp-mounting brackets 62 through a C-shaped clamp 84. Referring further to FIG. 7, a fine adjusting unit 80 includes an operating rod 81 extending through the connecting end 631 of the pivot pin 63 and having an engaging end 811 which is disposed underneath the lower rail rod 44, and a friction member 82 that is sleeved on and that is secured to the engaging end 811 of the operating rod 81 and that is in frictional contact with the lower rail rod 44. The operating rod 81 is rotatable so as to drive the pivot pin 63 together with the clamp-mounting brackets 62, the positioning unit, and the mounting plate 52′ of the sliding member 52 to slide relative to the rail unit 40 in the longitudinal direction by virtue of friction between the friction member 82 and the lower rail rod 44 when the clamping member 64 is disposed at the releasing position, thereby permitting fine adjustment of the position of the rip fence unit 50 on the rail unit 40.

Since positioning of the rip fence unit 50 on the base 21 of the table saw of this invention is conducted through upward and downward movement of the handle 70, the aforesaid drawbacks associated with the conventional table saw can be eliminated.

With the invention thus explained, it is apparent that various modifications and variations can be made without departing from the spirit of the present invention. It is therefore intended that the invention be limited only as recited in the appended claims.

We claim:

1. A table saw comprising:
a base;
a saw blade mounted rotatably on said base;
a rail unit mounted on said base and extending in a longitudinal direction;
a rip fence unit including a rip fence that extends in a transverse direction relative to said longitudinal direction, and a sliding member that is secured to said rip fence and that is disposed above and mounted slidably on said rail unit so as to be slidable toward and away from said saw blade in said longitudinal direction; and
a positioning unit mounted on said rip fence unit and including a clamping member that is disposed below and swingable toward and away from said rail unit, and that is operable by an external force applied thereto so as to swing between a clamping position, in which said clamping member abuts against said rail unit and cooperates with said sliding member to clamp said rail unit therebetween, thereby arresting sliding movement of said sliding member on said rail unit, and a releasing position, in which said clamping member is disconnected from said rail unit so as to permit sliding movement of said sliding member together with said rip fence on said rail unit.

2. The table saw of claim 1, wherein said base includes a front plate that has two opposite sides and that is formed with a pair of front studs projecting frontwardly and respectively from said opposite sides of said front plate, a pair of rail-mounting brackets, each of which is formed with a front sleeve that is sleeved on a respective one of said front studs, and a pair of rail-holding members that are respectively secured to said rail-mounting brackets and that define a pair of C-shaped upper retaining grooves which open upwardly and a pair of C-shaped lower retaining grooves which open downwardly, said rail unit including an upper rail rod that extends in said longitudinal direction into and through said upper retaining grooves and that abuts against said rail-holding members so as to be secured thereto, and a lower rail rod that is parallel to said upper rail rod and that extends in said longitudinal direction into and through said lower retaining grooves and that abuts against said rail-holding members so as to be secured thereto, said sliding member including a mounting plate and a pair of protrusions that project downwardly from said mounting plate and that define a pair of C-shaped recesses for extension of said upper rail rod therethrough, each of said recesses in said protrusions of said sliding member being defined by a recess-defining wall that is in sliding contact with said upper rail rod when said clamping member is disposed at said releasing position, and that abuts tightly against said upper rail rod when said clamping member is disposed at said clamping position.

3. The table saw of claim 2, wherein each of said rail holding members includes a screw bolt, a first half that is secured to the respective one of said rail-mounting brackets, and a second half that complements said first half and that is adjustably secured to said first half through said screw bolt so as to adjust dimensions of said upper and lower retaining grooves and thus the tightness of said upper rail rod in said upper retaining grooves and said lower rail rod in said lower retaining grooves.

4. The table saw of claim 3, wherein said base further includes a rear plate that has two opposite sides and that is formed with a pair of rear studs projecting rearwardly and respectively from said opposite sides of said rear plate, and a rear supporting plate that is formed with a pair of rear sleeves that are sleeved respectively on said rear studs, said rip fence having front and rear ends, said rip fence unit further including a rear mounting plate that is secured to said rear end of said rip fence and that is seated slidingly on said rear supporting plate, said mounting plate of said sliding member being secured to said front end of said rip fence.

5. The table saw of claim 4, wherein said mounting plate of said sliding member has front and bottom sides, said positioning unit further including a handle-mounting bracket that is secured to and that projects frontwardly from said front side of said mounting plate of said sliding member, a handle pivoted to said handle-mounting bracket, a pair of clamp-mounting brackets that are secured to said bottom side of said mounting plate of said sliding member and that are respectively disposed at two opposite sides of said handle-mounting bracket, and a guiding block that is disposed between and that is secured to said clamp-mounting brackets and that is formed with a guiding hole which extends in a vertical direction transverse to said longitudinal direction and said transverse direction, said clamping member being disposed below said guiding block, extending in said transverse direction, and having a driven end that is aligned with said guiding hole in said vertical direction, and a clamping end that is opposite to said driven end in said transverse direction and that is disposed underneath said lower rail rod, said clamping member being formed with a pivoting ear between said driven end and said clamping end of said clamping member, said pivoting ear being disposed between and being pivoted to said clamp-mounting brackets so as to permit swinging of said clamping member, said positioning unit further including a linking member that is pivoted to said handle, and a pressing rod that is pivoted to said linking member and that extends in said vertical direction into and through said guiding hole so as to press said driven end of said clamping member to move downwardly when said handle is turned downwardly, which results in upward movement of said clamping end and abutment of said clamping end against said lower rail rod, which, in turn, results in clamping of said rail unit between said clamping end of said clamping member and said protrusions of said sliding member.

6. The table saw of claim 5, wherein said positioning unit further includes a pivot pin that extends in said longitudinal direction through said clamp-mounting brackets and that has a connecting end disposed adjacent to one of said clamp-mounting brackets, and a fixed end that is fastened to the other of said clamp-mounting brackets, said table saw further comprising a fine adjusting unit that includes an operating rod extending through said connecting end of said pivot pin and having an engaging end which is disposed underneath said lower rail rod, and a friction member that is sleeved on and that is secured to said engaging end of said operating rod and that is in frictional contact with said lower rail rod, said operating rod being rotatable so as to drive said pivot pin together with said clamp-mounting brackets, said positioning unit, and said mounting plate of said sliding member to slide relative to said rail unit in said longitudinal direction by virtue of friction between said friction member and said lower rail rod when said clamping member is disposed at said releasing position, thereby permitting fine adjustment of the position of said rip fence unit on said rail unit.
